(19) United States
(12) Patent Application Publication
(10) Pub. No.: US 2016/0158949 A1
(43) Pub. Date: Jun. 9, 2016

(54) Razor Cartridge Guard Structure

(71) Applicant: The Gillette Company, Boston, MA (US)

(72) Inventors: Christopher Raymond Eagleton, Devizes (GB); Christopher Martin Hawes, Reading (GB)

(21) Appl. No.: 14/949,018

(22) Filed: Nov. 23, 2015

Related U.S. Application Data
(60) Provisional application No. 62/088,944, filed on Dec. 8, 2014.

(51) Int. Cl. B26B 21/40; B26B 21/44

(52) U.S. Cl. CPC B26B 21/4018; B26B 21/443

(57) ABSTRACT

A razor cartridge is provided comprising at least one blade having a cutting edge; a blade unit holding the at least one blade; and a guard positioned in front of the blade unit having a first portion and a second portion, wherein the first portion has a first fixed end joined to the blade unit and a first free end opposite the first fixed end, and the second portion has a second fixed end, a second free end, and a pivot axis joining the ends, wherein the pivot axis is positioned distally away from the blade unit and the second free end is positioned intermediate the pivot axis and the first free end.

### FIELD OF THE INVENTION

This invention relates to a razor cartridge, and more particularly to a guard structure of the razor cartridge

### BACKGROUND OF THE INVENTION

In general, a razor cartridge of a safety razor has a blade unit with at least one blade having a cutting edge, which is moved across the surface of the skin being shaved by means of a handle to which the razor cartridge is attached. The cartridge may be mounted detachably on the handle to enable the cartridge to be replaced by a fresh cartridge when the blade sharpness has diminished to an unsatisfactory level, or it may be attached permanently to the handle with the intention that the entire razor be discarded when the blade or blades have become dulled. Razor cartridges usually include a guard which contacts the skin in front of the blade(s) and a cap for contacting the skin behind the blade(s) during shaving. The cap and guard may aid in establishing the shaving geometry, i.e., the parameters which determine the blade orientation and position relative to the skin during shaving, which in turn have a strong influence on the shaving performance and efficacy of the razor. The guard may be generally rigid, for example formed integrally with a frame or platform structure which provides a support for the blades.

Guards are present on many shaving razors and are intended to stretch the skin; however, these guards also have a propensity to press hair against the skin. Moreover, some standard shaving razor guards have a generally rigid, hard surface with minimal ability to conform to the undulations of the skin found on the body, particularly around the jaw line for men and the knee and armpit areas for women. It would be desirable to have a guard structure, which can more readily provide adequate shaving performance attributes such as skin management, efficiency and safety, with a particular improvement in conforming to the user's skin. Various razors with known guard and cap structures have been disclosed. See, e.g., U.S. Pat. Nos. 5,092,042, 5,003,694, 5,056,222, 5,689,883, 5,903,979, and 5,915,791; and US Patent Pubs 2003/0204954 and 2003/0217470. Despite the many razor executions that have been described, there still remains a need for a new type of razor that can provide a different shaving experience, in particular with regard to how the razor contacts skin.

### SUMMARY OF THE INVENTION

In one embodiment, a razor cartridge is provided comprising at least one blade having a cutting edge; a blade unit holding the at least one blade; and a guard positioned in front of the blade unit having a first portion and a second portion, wherein the first portion has a first fixed end joined to the blade unit and a first free end opposite the first fixed end, and the second portion has a second fixed end, a second free end, and a pivot axis joining the ends, wherein the pivot axis is positioned distally away from the blade unit and the second free end is positioned intermediate the pivot axis and the first free end. In one embodiment, the pivot axis operably connects said fixed end and said free end such that said free end pivots about said pivot axis. In one embodiment, the free end is at least partially, or entirely, disposed over the fixed end, and a gap exists between the free end and the blade unit. The free end may have a curved profile. The free end may be formed of a first material and a layer of a second material may be disposed on the free end. Certain implementations of this embodiment of the razor cartridge may include one or more of the following features. The first material may be different than the second material. The second material may be selected from a variety of different materials that are suitable for use on the skin contacting surface of a razor cartridge. Non-limiting examples of suitable materials include thermoplastic elastomers (which can be smooth, or textured to provide different skin feel such as with the addition of fins or other commonly used surface treatments, see e.g. U.S. 2010/0313424, U.S. Pat. No. 6,675,479, U.S. Pat. No. 6,651,342, and U.S. Pat. No. 8,186,062), a lubricious material (such as a lubricating shaving as described herein, a Ribbon of Moisture such as present on Venus Embrace razor or see e.g. U.S. Pat. No. 5,711,076, U.S. Publication No. 2012/0090180, or combinations thereof, such as where the thermoplastic elastomer is coated with a lubricous material. In one embodiment, the first material is the same material that also forms the fixed end, and the second material is a coating or other feature present on part or all of the skin contacting surface of the free end.

The gap between the free end and the blade unit may be about 0.5 millimeters to about 2.5 millimeters. The pivot axis between the fixed end and the free end may be below a bottom surface of the blade unit. The free end of the guard may extend above a shaving plane of the blade unit. The guard may extend about 1 millimeter to about 10 millimeters in front of the blade unit. The pivot axis between the fixed end and the free end may have a thickness of about 0.1 millimeters to about 10 millimeters.

In another embodiment, a razor cartridge is provided comprising at least one blade having a cutting edge; a blade unit holding the at least one blade; and a guard positioned in front of the blade unit having a fixed end, a free end, and a pivot axis connecting the ends, wherein the pivot axis is positioned distally away from the blade unit and the free end is positioned intermediate the pivot axis and the blade unit. Certain implementations of this embodiment of the razor cartridge may include one or more of the following features. The free end may have a curved profile. The fixed end may be positioned between a first end and/or a second end of the blade unit and the pivot axis. The fixed end may be positioned about a perimeter of the free end. The fixed end may extend between a cap and the pivot axis. The fixed end may extend between the blade unit and the pivot axis. The pivot axis between the fixed end and the free end may be below a bottom surface of the blade unit. The free end of the guard may extend above a shaving plane of the blade unit. The guard may extend about 1 millimeter to about 10 millimeters in front of the blade unit. The pivot axis between the fixed end and the free end may have a thickness of about 0.1 millimeters to about 10 millimeters.

Other features and advantages of the invention will be apparent from the following detailed description and from the claims.

### BRIEF DESCRIPTION OF THE DRAWINGS

Embodiments of the invention will hereinafter be further described, by way of example, with reference to the accompanying drawings, in which like designations are used to designate substantially identical elements, and in which:

FIG. 1 is a perspective view of an embodiment of a razor cartridge of the present invention;

FIG. 2 is a side view of the razor cartridge of FIG. 1;

FIG. 3 is a schematic diagram of a guard which may be incorporated into the razor cartridge of the present invention; and

FIG. 4 is a schematic diagram of another guard which may be incorporated into the razor cartridge of the present invention.

### DETAILED DESCRIPTION OF THE INVENTION

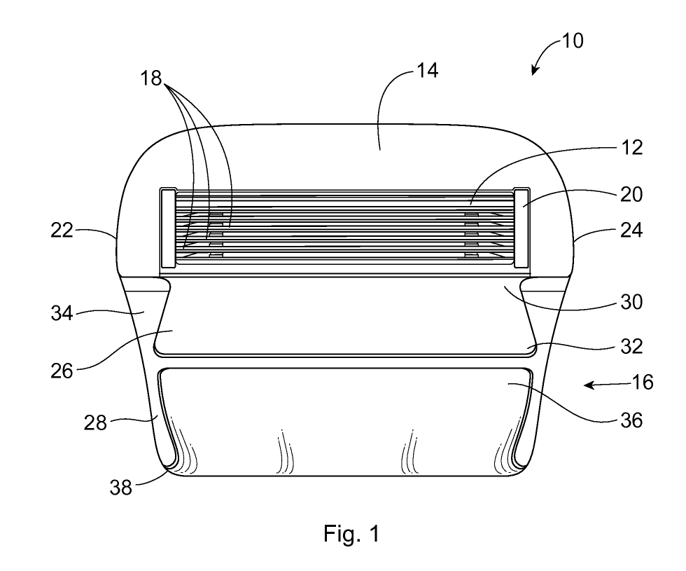

Referring to FIG. 1, one embodiment of the present disclosure is shown illustrating a razor cartridge 10 that includes a blade unit 12, a cap 14, and a guard 16. One or more blades 18 may be mounted to the blade unit 12. The blades 18 may be secured to the blade unit 12 with a pair of clips 20; however, other securing methods known to those skilled in the art may be used including, but not limited to, wire wrapping, cold forming, hot staking, insert molding, adhesives, and the like. Although five blades 18 are shown, it is understood that the blade unit 12 may have more or fewer blades 18. The blade unit 12 may include a cap 14 positioned behind the blade unit 12; behind the blade unit intended to mean disposed on a side of the blade unit 12 opposite the cutting edges of the blades 18. The guard 16 is positioned in front of the blade unit 12 opposite the cap 14, in other words, the guard 16 is disposed in front of the cutting edges of the blades 18.

As used herein, the terms “front” and “behind” define the relative position between features of the razor cartridge. A feature “forward” of the blade unit, for example, is positioned so that the surface to be treated by the razor cartridge encounters the feature before it encounters the cutting edge of the blade(s) in the blade unit. For example, if the razor cartridge is being stroked in its intended cutting direction, the guard is in front of the blade unit. A feature “behind” the blade unit is positioned so that the surface to be treated by the razor cartridge encounters the feature after it encounters the cutting edge of the blade(s) in the blade unit. For example, if the razor cartridge is stroked in its intended cutting direction, the cap is positioned behind of the blade unit.

The blade unit 12 may be injection molded from a semi-rigid material such as, for example, a polyphenylene oxide (PPO) and polystyrene blend, high impact polystyrene, polypropylene, acrylonitrile butadiene styrene (ABS), or any combination thereof. A semi-rigid material may allow the blade unit 12 to maintain a consistent geometry during shaving. The blade unit 12 may be of sufficient stiffness such that it does not bend or flex under normal shaving conditions, which may adversely influence the shave geometry of the razor cartridge 10.

The cap 14 is positioned behind the blade unit 12. In certain embodiments, the cap 14 may further extend about a first end 22 and a second end 24 of the blade unit 12 circumscribing three sides of the blade unit 12 with the guard 16 being disposed in front of the fourth side. In other embodiments, the cap 14 may be positioned only behind the blade unit 12, but not on the ends 22, 24 of the blade unit 12. The cap 14 may have a smooth surface and may provide lubrication to the skin by delivering a shaving aid behind the blade unit 12. In certain embodiments, the cap 14 may include a shaving aid, which provides, for example, lubricity, skin moisturizing and conditioning properties, and the like. The cap 14 may have sufficient wear resistance such that the cap 14 lasts for the intended life of the razor cartridge 10 (e.g., the blades become too dull to effectively shave hairs). In other embodiments, the cap 14 may be injection molded from semi-rigid polymeric materials that do not wear under normal shaving conditions, such as a blend of PPO and polystyrene, high impact polystyrene, polypropylene, ABS, polytetrafluoroethylene (PTFE), high density polyethylene (HPDE), acetal, nylon, or any combination thereof. The polymeric material may also be filled with materials such as silicone, molidium disulfide, or other lubricating agents known to those skilled in the art for reducing friction against the surface of the skin.

Those of skill in the art will appreciate that various shaving aids/skin engaging members can be used with the present invention. The skin engaging member can be positioned forward and/or aft of any blade(s), such as on the cap, on the guard, and/or on the free end of the guard of the present invention. Non-limiting examples of known skin conditioning compositions suitable for use herein include shave aids and lubrication strips as described in: U.S. Pat. Nos. 7,581,318, 7,069,658, 6,944,952, 6,594,904, 6,302,785, 6,182,365, D424,745, 6,185,822, 6,298,558 and 5,113,585, and 2009/0223057.

The guard 16 described herein generally extends beyond the housing of the razor cartridge 10, which generally includes the blade unit 12 and the cap 14. The guard 16 extends generally parallel to the blades 18 and is positioned in front of the blade unit 12. The guard 16 has a first portion 26 and a second portion 28. The first portion 26 has a first fixed end 30, joined to the blade unit 12, and a first free end 32 opposite the first fixed end. The second portion 28 has a second fixed end 34, a second free end 36, and a pivot axis 38 joining the second fixed end and free end. The pivot axis 38 may be positioned distally away from the blade unit 12 and the second free end 36 may be positioned intermediate the pivot axis 38 and the first free end 32. The second fixed end 34 may extend from the blade unit 12 to the pivot axis 38 or it may extend from the cap 14 to the pivot axis 38. The second portion 28 of the guard 16 is connected to the razor cartridge 10 through the second fixed end 34, which may be attached to the cap 14 and/or the blade unit 12, depending upon the configuration of those components in the razor cartridge.

One of skill in the art will understand that while described as individual elements of the razor cartridge, the housing, blade unit, cap, and various components of the guard (e.g., the fixed end) may be formed of the same material, such as where they are injection molded as a unitary structure.

The guard 16 deflects transversely relative to the blade to follow the contours of the skin. Without intending to be bound by theory, it is believed that by conforming to the skin, the guard 16 as described herein may enhance skin stretching and provide a more pleasant feel against the skin of the user during shaving, helping to provide a close shave. The flexibility of the guard 16 to conform to contours of a user's skin may tend to increase the surface area of the guard 16 that contacts the user's skin, enhancing skin stretch, and more uniformly distributing the force applied by the user during shaving. The guard 16 uniquely has a pivot axis isolated (e.g., positioned away and not adjacent to) from the blade unit and/or the cap. The position of the pivot point in the guard 16 permits the contouring movement of the guard to be at least at the point of the guard nearest the blades 18, which may help stretch out the skin and put the hairs in a desirable position just before the cut. Without intending to be bound by theory, it is believed the guard of the present invention can provide new and different shave experience during usage. It is further believed that depending on the usage conditions, this guard can provide users with different and more preferred skin stretching, or a different feel of resistance when applying a downward shave stroke.

In one embodiment, the guard comprises one or more lubricating members. Said lubricating members can be made of the same materials as used for the lubricating member optionally available on the cap, or can be made of different materials. In another embodiment, the guard comprises one or more fins. See, e.g., U.S. 2010/0313424, and U.S. Pat. No. 6,675,479. In one embodiment, the guard comprises one or more lubricating members and one or more fins.

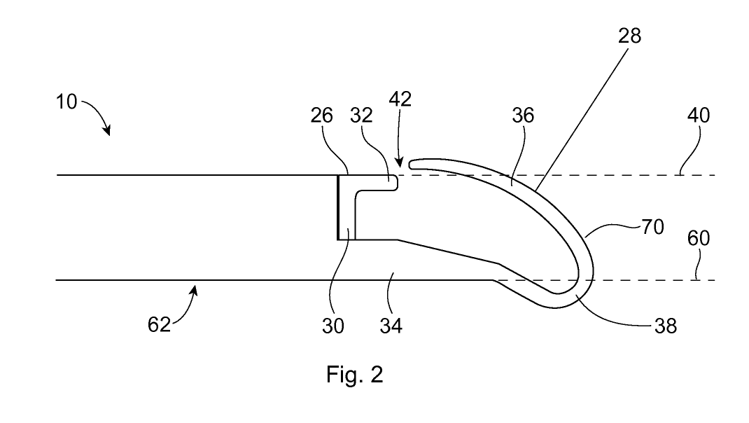

FIG. 2 is a partial side view of the razor cartridge 10. As can be more clearly seen in FIG. 2, the pivot axis 38 exists between the second fixed end 34 and the second free end 36 of the second portion 28 of the guard 16. The second free end 36 is intermediate the pivot axis 38 and the first free end 32, which is opposite the first fixed end 30 making up the first portion 26. One of skill in the art will understand that while described as individual elements of the razor cartridge, the housing, blade unit, cap, and various components of the guard (e.g., the first portion, etc.) may be formed of the same material, such as where they are injection molded as a unitary structure. One or both of the portions of the guard 16 deflect transversely relative to the blades 18 to follow the contours of the skin. The fixed ends may be supported by at least the blade unit 12 and the free ends may be unsupported to facilitate flexing of at least one of the free ends under normal shaving forces. In other words, the first free end 32 and/or the second free end 36 are configured to move between a first position and a second position during a shave stroke. By conforming to the skin, the guard 16 as described herein may enhance skin stretching and provide a more pleasant feel against the skin of the user during shaving, helping to provide a close shave. The flexibility of the guard 16 to conform to contours of a user's skin may tend to increase the surface area of the guard 16 that contacts the user's skin, enhancing skin stretch, and more uniformly distributing the force applied by the user during shaving. Without intending to be bound by theory, it is believed the guard of the present disclosure provides a new and different shave experience during usage. It is further believed that depending on the usage conditions, this guard can provide users with different and more preferred skin stretching, a different feel of resistance when applying a downward shave stroke, and the like. Optionally, the guard 16 may further include lubrication members, for example on a skin contacting surface of the free end 32, elastomeric fins, and other guard features known to a person of skill in the art.

As illustrated in FIG. 2, the first fixed end 30 and the second fixed end 34 may be joined to the blade unit 12 at a point below the shave plane 40 of the razor cartridge 10. As used herein, “shave plane” is intended to mean a plane that is tangent to two or more of the cutting edges of the blades 18. For example, the blade 18 closest to the guard 16 and the blade 18 furthest from the guard 16 may define and be tangent to the shave plane. Additional blades 18 may be positioned above, below, or on the shave plane 40. In another embodiment, the one or both of the fixed ends of the guard 16 may be joined to the cap 14. For example, the cap 14 may extend about the ends 22, 24 of the blade unit and connect with at least a portion of one or both of the fixed ends. This may be the only connection of the guard 16 to the razor cartridge 10, or the guard 16 may be connected to both the cap 14 and the blade unit 12. The guard 16 may be joined to the blade unit 12 and/or the cap 14 by insert molding or co-injection molding. Other mechanical or chemical assembly/securing methods known to those skilled in the art may also be used to join the guard 16, such as adhesives, wire wrapping, mechanical fasteners, and the like.

In FIG. 2, the second free end 36 is at least partially disposed over the second fixed end 34, because the free end is positioned closer to the shave plane than the second fixed end 34 (in this embodiment the second free end is above the shave plane). Whereas, the first free end 32 is on the same plane as the first fixed end 30 (in this embodiment, both ends are on the shave plane). However, each free end may be on the same plane or they may be on different planes, and each free end may be the same distance from and orientation to (i.e., above or below) the shave plane or they could be different distances from and orientations to the shave plane. In one embodiment, the second free end is wholly disposed over the fixed end, meaning no portion of the free end extends beyond a corresponding portion of the second fixed end when a user looks at the shaving razor from a top view perpendicular to the shave plane. In one embodiment, the entire second fixed end can be obscured by the second free end when looking from this same top view.

As used herein, the term “disposed over” is generally intended to mean that the position of one feature is located closer to the shave plane than another feature. In some embodiments of the guard of the present disclosure, at least a portion or the free end may be positioned directly over the fixed end. Likewise, at least a portion of the fixed end may be positioned directly beneath the free end. In other embodiments, there is no overlap of the fixed end and the free end (e.g., no portion of the fixed end is directly beneath the free end). However, there may also be portions of the guard whereby the fixed end and free end are disposed on the same plane (above, below or on the shave plane), and therefore neither end is disposed over the other.

The second free end 36 has a generally curved profile, whereas the first free end 32 is relatively straight. However, each free end may have the same profile, whether curved, straight, angled, or some other profile. A portion of at least one of free ends extends above the shave plane 40. In FIG. 2, the second free end 36 is shown extending above the shave plane 40, but in other embodiments the first free end 32 may extend above the shave plane in addition to or instead of the second free end 36. By extending above the shave plane, the guard 16 engages the user's skin first. A pivot axis, such as the pivot axis 38 of the second portion 28, permits movement of the free end when under load during normal shaving conditions, such that the free end deflects down to or below the shave plane 40, providing the user with a sense of comfort and closeness during the shave. As shown in FIG. 2, a gap 42 may exist between the first portion 26 and the second portion 28, specifically between the first free end 32 and the second free end 36.

The gap 42 may provide space for shave preps, such as shaving cream, to pass through to help prevent the guard 16 from being clogged with shave prep, shaved hairs, and the like. The gap 42 may also help to generally improve the rinsability of the razor cartridge 10. The gap 42 between the free ends may be about 0.5 millimeters (“mm”) to about 2.5 mm; specifically about 0.75 mm to about 2 mm; and more specifically about 1 mm to about 1.5 mm. An additional gap (not shown) may exist between the first portion 26 and the blade unit 12, which may provide for the unobstructed passage of hair to the blades 18.

As stated, the pivot axis 38 permits movement of the second free end 36 when under load during normal shaving conditions, such that the second free end 36 deflects down, providing the user with a sense of comfort and closeness during the shave. When the load is removed, such as when the razor cartridge 10 is separated from the skin, the second free end 36 returns generally to the original position. During a shave stroke, the second free end 36 of the guard 16 deflects in a direction transverse to the blades 18. The amount of deflection of the second free end 36 may vary as the guard 16 follows the contours of the skin during shaving. As the razor cartridge 10 glides across the surface of the skin, the guard 16 may stretch the skin to reduce skin bulges (which can lead to nicks and cuts).

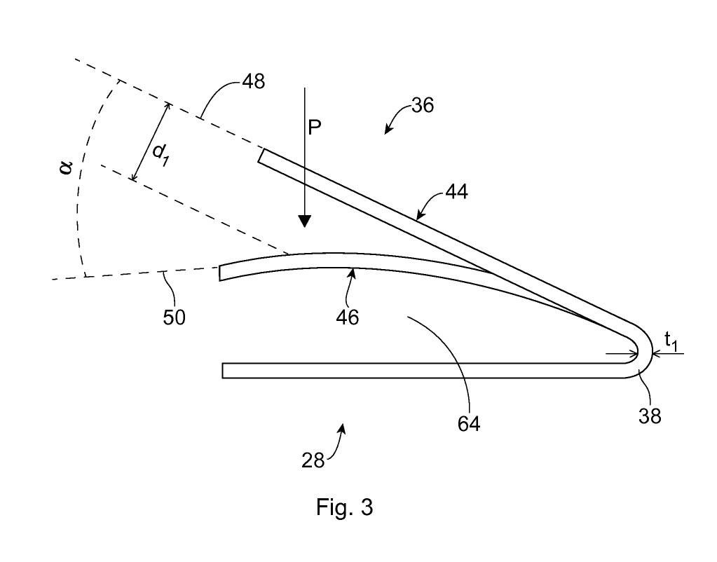

Referring to FIG. 3, a schematic diagram representing the second portion 28 of the guard 16 is shown. The second free end 36 is movable between a first position 44 and a second position 46. In the first position 44, at least a portion of the second free end 36 may have a longitudinal axis 48 that extends transverse to the blade unit 12. The second free end 36 may be unloaded in the first position 44 such that the free end is not deflected relative to the blade unit 12. During shaving, the force of razor cartridge 10 against the surface of the skin may apply a load P, which causes the second free end 36 to deflect resulting in the second position 46. In the second position 46 (e.g., during shaving), at least a portion of the second free end 36 may have a longitudinal axis 50 that is deflected at an angle relative to the longitudinal axis 48 (e.g., below the longitudinal axis 48). An angle of deflection α₁ of the longitudinal axis 50 of the second free end 36 relative to the longitudinal axis 48 (and/or the blade unit 12) may be about 5 degrees to about 40 degrees; specifically about 10 degrees to about 30 degrees; and more specifically about 15 degrees to about 25 degrees. While FIG. 3 illustrates a bending of the second free end 36, resulting in an angle of deflection α₁, it is to be understood that the free end could also deflect linearly a distance d₁ with no curving of the free end resulting in an angle of deflection. Whether or not the second free end 36 bends rather than simply deflecting about the pivot axis 38 may depend on the profile of the second free end 36, the thickness of the pivot axis and/or the free end, a gap between the free end and the fixed end 34, combinations thereof, and the like, and such construction of the guard 16 to produce a desired deflection distance and/or angle is within the skill of a person in the art.

The applied load may cause the second free end 36 to deflect a distance d₁ of about 0.1 mm to about 4 mm; specifically about 0.5 mm to about 3 mm; and more specifically about 1 mm to about 2 mm. The force needed for the applied load to deflect the second free end 36 by the distance d₁ may vary depending on where along the length of the free end the load P is applied, as well as the geometry and dimensions of the guard 16. The width and unsupported length of the second free end 36, and the thickness t₁ of the pivot axis 38 may all be varied to increase or decrease the force required to deflect the second free end 36. For example, one particular embodiment of the guard 16 which may provide sufficient flexibility may include a pivot axis 38 with a thickness of about 0.1 mm to about 10 mm; or from about 0.5 millimeters to about 5 millimeters, or from about 1 millimeter to about 2.5 millimeters. Lines of weakness or structural reinforcing features may also be included in the pivot axis 38 to affect flexibility of the second portion 28 of the guard 16. Likewise, the material selected to form at least the pivot axis 38 may affect the guard 16 flexibility. Moreover, the positioning of the pivot axis 38 relative to the blade unit may affect the flexibility and load requirements of the guard 16. In one embodiment, the pivot axis 38 is positioned below a plane 60 of the bottom surface 62 of the blade unit 12 (as shown in FIG. 2). While the pivot axis described herein has been primarily referred to and illustrated as a living hinge due to its ability to form the second portion as a unitary structure, it is to be understood that other well known pivot mechanisms may be used, such as hinges, joints, combinations thereof, and the like.

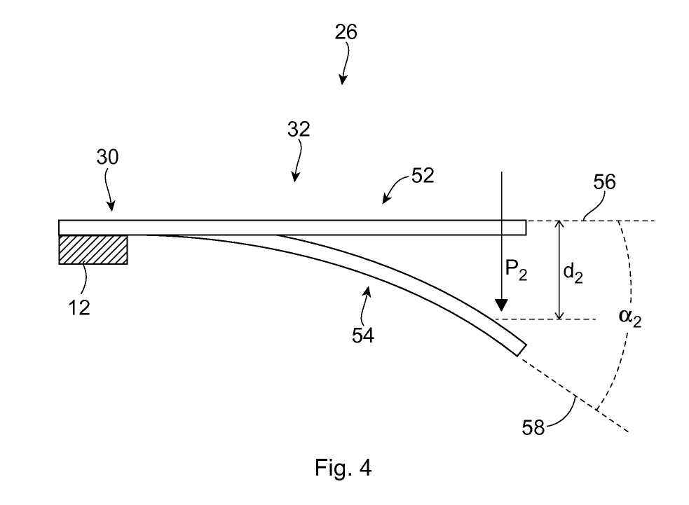

The support structure can be as described and shown herein (where a free end is folded/disposed over a fixed end and attached via a pivot axis), but can also have different designs, such as where the fixed end can be generally co-planar with the free end (such as where the fixed end comprises one or a pair of support arms wrapping around the free end and attached to the free end at a similar position as shown in FIG. 2—distally away from the forward most blade). This can be similar to the embodiment shown in FIG. 4, but with the portion of the fixed end residing below the free end being an aperture. In one embodiment, the aperture can have the same general peripheral shape as the entire free end or just a portion of the free end. In such an embodiment, it can be possible in some instances for a portion of the free end (i.e. the portion closest to the blade unit) can be pushed back towards the fixed end and at least partially through the aperture. Those of skill in the art would understand, however, that it could be preferable for an embodiment of the invention to have sufficient resistance in the pivot axis that the free end would not pass below the shaving plane when force is applied, or no more than about 0.1 mm below the shaving plane, or no more than about 0.5 mm below the shaving plane, or no more than about 1 mm below. In one embodiment, said fixed end forms an aperture and at least a portion of said free end is disposed over said aperture.

Having the bottom surface of the free end (i.e. the surface opposite the skin contacting surface) exposed it can assist with rinse ability of the entire cartridge and minimize the possibility of hairs, shaving preparation or other shaving debris from being entrapped within the varying structures of the device.

A gap 64 may also exist between second free end 36 and the fixed end 34 where the free end is disposed over the fixed end. In an embodiment of the razor cartridge having such a gap 64, the distance d₁ may at least partially depend on the size of the gap 64. As shown in FIG. 3, the gap 64 exists between the distal end of the second free end 36 of the guard 16 and a portion of the fixed end 34 generally nearer the blade unit 12. In one embodiment, the second fixed end 34 may provide a hard stop for deflection of the second free end 36. In other words, the distance d₁ would equal the length of the gap 64. In another embodiment, guard 16 may be designed (such as by determining the necessary thickness of the pivot axis 38, which may act as a living hinge) so that the distance d₁ is less than a length of the gap 64. The gap 64 between the second free end 36 and the second fixed end 34 may be about 0.5 mm to about 5 mm; specifically about 1 mm to about 4 mm; and more specifically about 1.5 mm to about 2.5 mm.

In one embodiment of the guard 16, only the second portion 28 is configured to move (e.g., deflect) during shaving. In another embodiment, the first portion 26 and the second portion 28 may be configured to move during shaving. The first portion 26 may have a pivot mechanism the same as the second portion 28 or it may have a different mechanism for permitting movement of the first free end 32.

Referring now to FIG. 4, a schematic diagram representing the first portion 26 of the guard 16 is shown. The first free end 36 is movable between a first position 52 and a second position 54. In the first position 52, at least a portion of the first free end 32 may have a longitudinal axis 56 that extends transverse to the blade unit 12. The first free end 36 may be unloaded in the first position 52 such that the free end is not deflected relative to the blade unit 12. During shaving, the force of razor cartridge 10 against the surface of the skin may apply a load P₂, which causes the first free end 32 to deflect resulting in the second position 54. In the second position 54 (e.g., during shaving), at least a portion of the first free end 32 may have a longitudinal axis 58 that is deflected at an angle relative to the longitudinal axis 56 (e.g., below the longitudinal axis 56). An angle of deflection α₂ of the longitudinal axis 58 of the first free end 32 relative to the longitudinal axis 56 (and/or the blade unit 12) may be about 5 degrees to about 40 degrees; specifically about 10 degrees to about 30 degrees; and more specifically about 15 degrees to about 25 degrees. The force needed for the applied load to deflect the first free end 32 by the distance d₂ may vary depending on where along the length of the free end the load P₂ is applied, as well as, the geometry and dimensions of the free end. The width, the unsupported length, and the thickness of the free end 32 may all be varied to increase or decrease the force required to deflect the first portion 26. Again, while FIG. 4 illustrates a bending of the first free end 32, resulting in an angle of deflection α₂, it is to be understood that the free end could also deflect linearly a distance d₂ with no curving of the free end resulting in an angle of deflection.

The guard 16 extends along at least a portion of the length of the blade unit 12. In one embodiment, the guard 16 may extend along the entire length of the blade unit 12. In another embodiment, the guard 16 may extend along only a portion of the length of the blade unit 12. In yet another embodiment, the guard 16 may extend beyond the entire length of the blade unit 12, such that the length of the guard 16 extends beyond one or both ends 22, 24 of the blade unit 12. The guard 16, as illustrated in FIG. 1, has a generally rectangular cross section, but numerous cross sectional shapes are possible, such as circles, squares, triangles, ovals, trapezoids, combinations thereof, and the like. The guard 16 may have a depth, as measured by the distance the guard extends in front of the blade unit 12, of about 1 mm to about 5 mm; specifically about 1.5 mm to about 4 mm; and more specifically about 2 mm to about 3 mm.

The guard 16 generally may have planar or non-planar surfaces, may be contiguous, non-contiguous, patterned, or any combination thereof. It may be made by injection molding techniques for low cost and the manufacturing simplicity of using a single material (e.g., as the housing). The guard 16 may be made of a single material, forming the first portion and the second portion, wherein the material provides suitable flexibility in the pivot axis to permit the desired deflection of the first and/or second free end. Alternatively, the first portion 26 and the second portion 28 can be formed of different materials. Moreover, the second fixed end 36 and second free end 34 of the second portion 28 can be formed of a first material and the pivot axis 38 can be formed of a second material. Moreover, the top surfaces of the free ends, which engage the skin, may include a layer or layers of a material different than that of the rest of the guard structure. In one embodiment, the guard 16 may fully comprise a hard plastic material such as polystyrene, polyphenylene oxide, polypropelene, acrylonitrile butadiene styrene, high impact polystyrene, combinations thereof, and the like. In another embodiment, at least a portion of the guard 16, such as the free ends, the pivot axis and/or a top surface layer may comprise a material different than that of the remainder of the guard 16. For example, the free end, the pivot axis and/or the layer may include a resilient material to facilitate flexing of the free end(s) in a direction transverse to the blades 18.

The resilient material may also improve tactile sensation against the skin and provide improved stretching of the skin compared to more rigid materials. For example, the resilient material may have a Shore A hardness of about 20 to about 70; specifically about 30 to about 60; and more specifically about 40 to about 50. The free ends, the pivot axis and/or the layer may be molded from thermoplastic elastomers (TPEs) or rubbers; examples may include, but are not limited to silicones, natural rubber, butyl rubber, nitrile rubber, styrene butadiene rubber, styrene butadiene styrene (SBS) TPEs, styrene ethylene butadiene styrene (SEBS) TPEs, polyester TPEs, polyamide TPEs, polyurethane TPEs, polyolefin based TPEs, and blends of any of these TPEs (e.g., polyester/SEBS blend).

The razor cartridge of the present disclosure may be used with a power or manual, disposable or a refillable razor system. The razor cartridge may also include multiple blades. For example, U.S. Pat. No. 7,168,173 generally describes a Fusion® razor that is commercially available from The Gillette Company which includes a razor cartridge with multiple blades.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified. Further, as used herein, where a group is described to be “comprising of” a list of group members, that group may also “consist essentially of” or “consist of” that same list of group members.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A razor cartridge comprising:
at least one blade having a cutting edge;
a blade unit holding the at least one blade; and
a guard positioned in front of the blade unit having a first portion and a second portion, wherein
the first portion has a first fixed end joined to the blade unit and a first free end opposite the first fixed end, and
the second portion has a second fixed end, a second free end, and
a pivot axis joining the ends, wherein the pivot axis is positioned distally away from the blade unit and the second free end is positioned intermediate the pivot axis and the first free end.

2. The razor cartridge of claim 1, wherein the second fixed end extends from the blade unit to the pivot axis.

3. The razor cartridge of claim 1, further comprising a cap positioned behind the blade unit.

4. The razor cartridge of claim 3, wherein the second fixed end extends from the cap to the pivot axis.

5. The razor cartridge of claim 1, wherein the first free end and/or the second free end are configured to move between a first position and a second position during a shaving stroke.

6. The razor cartridge of claim 1, wherein the second free end has a curved profile.

7. The razor cartridge of claim 1, wherein the pivot axis is below a bottom surface of the blade unit.

8. The razor cartridge of claim 1, wherein the first free end and/or the second free end extends above a shaving plane of the blade unit.

9. The razor cartridge of claim 1, wherein the guard extends about 1 millimeter to about 5 millimeters in front of the blade unit.

10. The razor cartridge of claim 1, wherein the pivot axis has a thickness of about 0.1 millimeters to about 10 millimeters.

11. A razor cartridge comprising:
at least one blade having a cutting edge;
a blade unit holding the at least one blade; and
a guard positioned in front of the blade unit having a first portion and a second portion, wherein
the first portion has a first fixed end joined to the blade unit and a first free end opposite the first fixed end, and the second portion has a second fixed end joined to the blade unit and a second free end, with a pivot axis between the second fixed end and the second free end, wherein the second free end is disposed over the second fixed end, and a gap exists between the first free end and the second free end.

12. The razor cartridge of claim 11, wherein the second free end has a curved profile.

13. The razor cartridge of claim 11, wherein the second fixed end extends between the blade unit and the pivot axis.

14. The razor cartridge of claim 1, wherein the gap is about 0.5 millimeters to about 2.5 millimeters.

15. The razor cartridge of claim 11, wherein the pivot axis is below a bottom surface of the blade unit.

16. The razor cartridge of claim 11, wherein the first free end and/or the second free end extends above a shaving plane of the blade unit.

17. The razor cartridge of claim 1, wherein the guard extends about 1 millimeter to about 5 millimeters in front of the blade unit.

18. The razor cartridge of claim 1, wherein the pivot axis has a thickness of about 0.1 millimeters to about 10 millimeters.

19. The razor cartridge of claim 1, wherein the second portion is a unitary structure.

20. The razor cartridge of claim 1, wherein a second gap exists between the second fixed end and the second free end.
